(19) United States
(12) Patent Application Publication
(10) Pub. No.: US 2006/0192764 A1
(43) Pub. Date: Aug. 31, 2006

(54) Navigation wheel having switching assembly

(75) Inventor: Kabir Siddiqui, Sammamish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/069,884

(22) Filed: Feb. 28, 2005

(51) Int. Cl. G09G 5/00

(52) U.S. Cl. 345/169

(57) ABSTRACT

An ergonomic pointing device receives user commands for controlling an electronic device. Typically a switching assembly is provided underneath a navigation wheel. The switching assembly comprises switches for generating and/or modulating signals in response to the received commands. Locating the switches in the switching assembly allows, for example, increased manufacturing tolerances. Additionally, the switching assembly can be secured to a device base such as a printed circuit board of the electronic device using, for example, a solder reflow process. Attaching the wheel assembly to the base permits, for example, the use of materials (such as rubber) and colors for the wheel that would otherwise be incompatible with a high temperature process.

### BACKGROUND OF THE INVENTION

Small, mobile devices such as hand-held and pocket-sized computers, tablet computers, cellular telephones and the like, are becoming important and popular tools. In general, they have become small enough to be extremely convenient, while consuming less battery power, and at the same time have become capable of running more powerful applications.

Pointing and/or selection devices for entering commands into such mobile devices are currently available in a variety of configurations. Mechanical encoder wheels are often used in various mobile devices as part of the user interface. Many such mechanical encoder wheels include a rotatable wheel or roller mounted on the device. As the wheel is moved, transducers sense the movement of the wheel and generate signals that indicate the direction and amount of the movement. The signals are used, for example, to control movement of a cursor on the screen of the mobile device. The signals may also be used, for example, for scrolling a window that is displayed on the screen in a way that is similar to using the scroll bar of a window to scroll the window.

The shrinking size of mobile devices often entails using smaller pointing devices. However, the smaller features of the smaller input devices commonly result in increased manufacturing difficulties and reliability problems (including increased wear). Manufacturing difficulties typically result in increased cost of manufacturing the mobile devices that comprise the smaller pointing devices. Reliability problems may result in intermittent functionality of the wheel such that, for example, the scrollable window may appear to jump or the wheel may appear to move discontinuously. In more extreme cases, the wheel could fail entirely, which can render the mobile device unusable and require expensive replacement or repair.

### SUMMARY OF THE INVENTION

Briefly stated, the present invention is directed towards an ergonomic pointing device for receiving commands from a user for controlling an electronic device. Typically a switching assembly is provided underneath a navigation wheel. The switching assembly comprises switches for generating and/or modulating signals in response to the received commands. Locating the switches in the switching assembly allows, for example, increased manufacturing tolerances. Additionally, the switching assembly can be secured to a device base such as a printed circuit board of the electronic device using, for example, a solder reflow process. Attaching the wheel assembly to the base permits, for example, the use of materials (such as rubber) and colors for the wheel that would otherwise be incompatible with a high temperature process.

In accordance with an aspect of the present invention, a pointing device for controlling an electronic device is disclosed comprising: a wheel assembly that comprises a wheel, wherein the wheel assembly is arranged to modulate a signal in response to rotation of the wheel by a user; a switching assembly that comprises a first, second, and third switch, each of which are generally configured to modulate a signal in response to a user depressing the wheel; and a device base that is arranged to physically secure the wheel assembly to the switching assembly.

In accordance with another aspect of the present invention, a pointing device for controlling an electronic device is disclosed comprising: a wheel means that comprises a wheel, wherein the wheel assembly is arranged to modulate a signal in response to rotation of the wheel by a user; a switching means that comprises a first, second, and third switch, each of which are generally configured to modulate a signal in response to a user depressing the wheel; and a device base means that is arranged to physically secure the wheel assembly to the switching assembly.

In accordance with yet another aspect of the present invention, an electronic device is disclosed comprising: a wheel assembly that comprises a wheel, wherein the wheel assembly is arranged to modulate a signal in response to rotation of the wheel by a user; a switching assembly that comprises a first, second, and third switch, each of which are generally configured to modulate a signal in response to a user depressing the wheel; a device base that is arranged to physically secure the wheel assembly to the switching assembly; and a processor that is arranged to receive the produced signals.

An appreciation of the present invention and its improvements can be obtained by reference to the accompanying drawings, which are briefly summarized below, to the following detailed description of illustrated embodiments of the invention, and to the appended claims.

### BRIEF DESCRIPTION OF THE DRAWINGS

FIG. 1 illustrates an exemplary electronic device in accordance with the present invention.

FIG. 2 is a functional block diagram illustrating an embodiment of functional components of an example electronic device in accordance with the present invention.

FIG. 3 is an exploded-view diagram generally illustrating components of a wheel assembly device in accordance with the present invention.

FIG. 4 is a view diagram generally illustrating components of a partially assembled switching assembly in accordance with the present invention.

FIG. 5 is an exploded-view diagram generally illustrating components of a wheel assembly device in accordance with the present invention.

FIG. 6 is a view diagram generally illustrating a wheel assembly device having a turntable in landscape orientation in accordance with the present invention.

FIG. 7 is a view diagram generally illustrating a wheel assembly device having a turntable in portrait orientation in accordance with the present invention.

FIG. 8 is an exploded-view diagram generally illustrating a wheel assembly device having a turntable in accordance with the present invention.

FIG. 9a is a top-view diagram generally illustrating components of a wheel assembly device in accordance with the present invention.

FIG. 9b is a bottom-view diagram generally illustrating components of a wheel assembly device in accordance with the present invention.

### DETAILED DESCRIPTION OF THE INVENTION

In the following detailed description of exemplary embodiments of the invention, reference is made to the accompanied drawings, which form a part hereof, and which is shown by way of illustration, specific exemplary embodiments of which the invention may be practiced. These embodiments are described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined only by the appended claims.

Throughout the specification and claims, the following terms take the meanings explicitly associated herein, unless the context clearly dictates otherwise. The meaning of “a,” “an,” and “the” includes plural reference, the meaning of “in” includes “in” and “on.” The term “connected” means a direct electrical connection between the items connected, without any intermediate devices. The term “coupled” means either a direct electrical connection between the items connected, or an indirect connection through one or more passive or active intermediary devices. The term “circuit” means either a single component or a multiplicity of components, either active and/or passive, that are coupled together to provide a desired function. The term “signal” means at least one current, voltage, or data signal. Referring to the drawings, like numbers indicate like parts throughout the views.

Briefly stated, the present invention is directed towards an ergonomic pointing device for receiving commands from a user for controlling an electronic device. Typically a switching assembly is provided underneath a navigation wheel. The switching assembly comprises switches for generating and/or modulating signals in response to the received commands. Locating the switches in the switching assembly allows, for example, increased manufacturing tolerances. Additionally, the switching assembly can be secured to a device base such as a printed circuit board of the electronic device using, for example, a solder reflow process. Attaching the wheel assembly to the base permits, for example, the use of materials (such as rubber) and colors for the wheel that would otherwise be incompatible with a high temperature process.

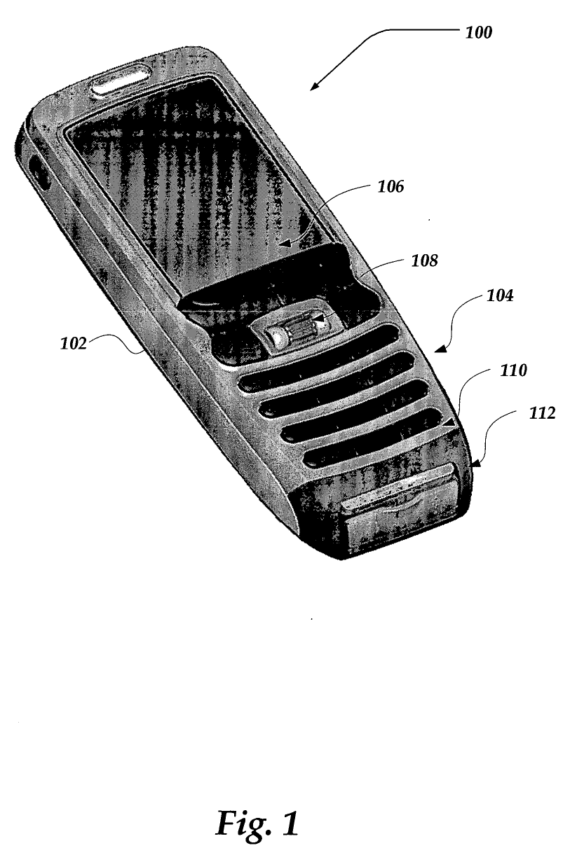

FIG. 1 illustrates an exemplary electronic device in accordance with the present invention. Mobile device 100 may include many more or less components than those shown. The components shown, however, are sufficient to disclose an illustrative embodiment for practicing the invention. Mobile device 100 includes case 102. Case 102 typically is arranged to support and protect user interface instrumentalities such as keypad 104 and display 106. Keypad 104 is often programmable and can be used for functions such as text input, game functions, phone dialing, and the like. Display 106 may optionally contain a touch screen interface, which can also be used for input of text. Display 106 may be used to display maps, text, games, pictures, and the like. Wheel 108 may be used in conjunction with Display 106 to enable manipulation and selection of displayed information by a user. Fascia 110 typically overlies keypad 104 and display 106 and can be used to display legends for buttons, brand names, and the like. Boot 112 can be extended outwards from case 102, which can be used to release keypad 104 and fascia 110 for replacement. Keypad 104 and fascia 110 can be customized for different applications such as game playing, text entry, phone dialing, and the like.

Generally, mobile device 100 may include virtually any portable computing device capable of receiving and transmitting signals between another mobile device, and providing audio signals, such as ringer tones, and the like. Such devices include cellular telephones, smart phones, audio pagers, radio frequency (RF) devices, infrared (IR) devices, integrated devices combining one or more of the preceding devices, and the like. Mobile device 100 may also include other devices, such as Personal Digital Assistants (PDA) with audio functions, handheld computers, wearable computers, and the like. As such, mobile device 100 typically ranges widely in terms of capabilities and features.

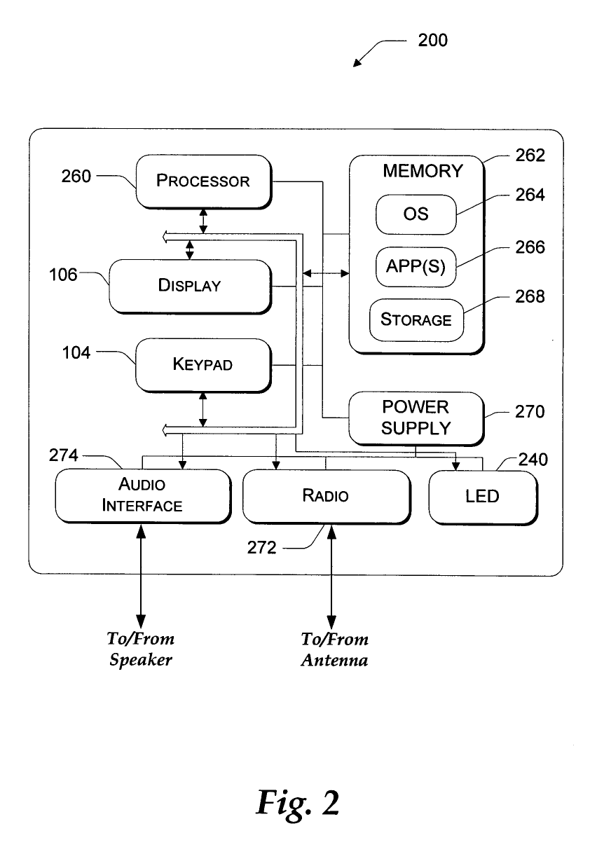

FIG. 2 is a functional block diagram illustrating an embodiment of functional components of an example electronic device in accordance with the present invention. Components 200 may include many more or less components than those shown. The components shown, however, are sufficient to disclose an illustrative embodiment for practicing the invention.

As shown in the figure, components 200 include processor 260, memory 262, display 106, and keypad 104. Memory 262 generally includes both volatile memory (e.g., RAM) and non-volatile memory (e.g., ROM, Flash Memory, or the like). Components 200 may include an operating system 264, such as the Windows CE operating system from Microsoft Corporation or other such operating system, which is resident in memory 262 and executes on processor 260. Keypad 104 may be a push button numeric dialing pad (such as on a typical telephone), a game pad, or the like. Display 106 may be a liquid crystal display, or any other type of display commonly used in a mobile communications device. For example, display 106 may be touch-sensitive, and would then also act as an input device.

One or more application programs 266 may be loaded into memory 262 and run on operating system 264. Examples of application programs include phone dialer programs, email programs, user ringer tone selection programs, and so forth. The application programs may operate in conjunction with wheel 108 to, for example, allow a user to select a particular data field displayed in a list. Components 200 also include non-volatile storage 268 within memory 262. Non-volatile storage 268 may be used to store persistent information which should not be lost if the mobile device 100 is powered down. The application programs 266 may use and store information in storage 268, such as e-mail, user selectable ringer tones, and the like.

Components 200 also include power supply 270, which may be implemented as one or more batteries. Power supply 270 might further include an external power source, such as an AC adapter or a powered docking cradle that supplements or recharges the batteries.

Components 200 are also shown with two types of external notification mechanisms: LED 240 and audio interface 274. These devices may be directly coupled to power supply 270 so that when activated, they remain on for a duration dictated by the notification mechanism even though processor 260 and other components might shut down to conserve battery power. LED 240 may be programmed to remain on indefinitely until the user takes action to indicate the powered-on status of the device. Audio interface 274 is used to provide audible signals to and receive audible signals from the user. For example, audio interface 274 may be coupled to a speaker for providing audible output. The audible output may be provided in response to an input command such as a button press or manipulation of wheel 108. Audio interface 274 may also be coupled to a microphone, receiving speaker, or the like, for receiving audible input, such as to facilitate a telephone conversation.

Components 200 also include radio 272 that performs the function of transmitting and receiving radio frequency communications. Radio 272 may be coupled to an antenna. Radio 272 facilitates wireless connectivity between components 200 and the outside world, via a communications carrier or service provider. Transmissions to and from radio 272 are conducted under the control of operating system 264 such that communications received by radio 272 may be disseminated to application programs 266 via operating system 264, and vice versa.

Radio 272 allows components 200 to communicate with other computing devices, such as over a network. Radio 272 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Briefly stated, the present invention is directed towards an ergonomic pointing device for receiving commands from a user for controlling an electronic device. Typically a switching assembly is provided underneath a navigation wheel. The base comprises switches for generating and/or modulating signals in response to the received commands. Locating the switches in the base allows, for example, increased manufacturing tolerances. Additionally, the switching assembly can be secured to a printed circuit board of the electronic device using, for example, a solder reflow process. Attaching the wheel to the base permits, for example, the use of materials (such as rubber) and colors for the wheel that would otherwise be incompatible.

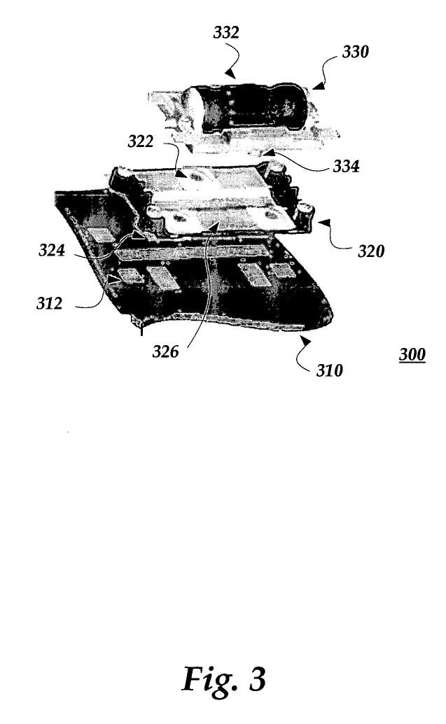

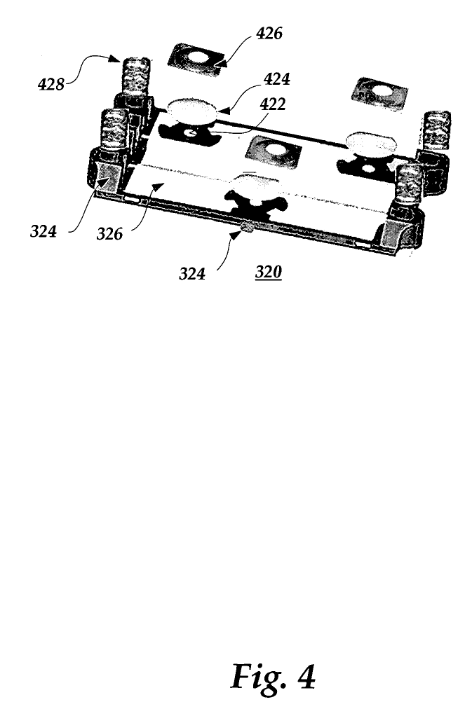

FIG. 3 is an exploded-view diagram generally illustrating components of a wheel assembly device in accordance with the present invention. Illustrated in assembly 300 are device base 310, switching assembly 320, and wheel assembly 330. In general, wheel assembly 330 is used to form signals for, for example, scrolling movements when the user rotates wheel 332. Additionally, the user can close (or open) switches (such as may be formed by dome switches 322) by depressing wheel assembly in a substantially downwards direction (which is discussed more fully with respect to FIG. 4). Thus, the user can, for example, depress the wheel assembly to activate dome switches for selection of an item in a list shown in display 106 (shown in FIG. 1).

Pivot pin 334 is optional and can be used to prevent the selection of two dome switches simultaneously. (The pivot pin and other features are more fully described in application Ser. No. 10/929,162, filed on Aug. 30, 2004, which is hereby incorporated by reference.) Pivot pin 334 can rest on and pivot upon switching assembly surface 326. Switching assembly surface 326 can be made of a relatively hard material (such as metal) to provide for increased durability and decreased wear at the point of contact of pivot pin 334. Switching assembly surface 326 may also be used to convey electrical signals if the switching assembly surface (326) is conductive.

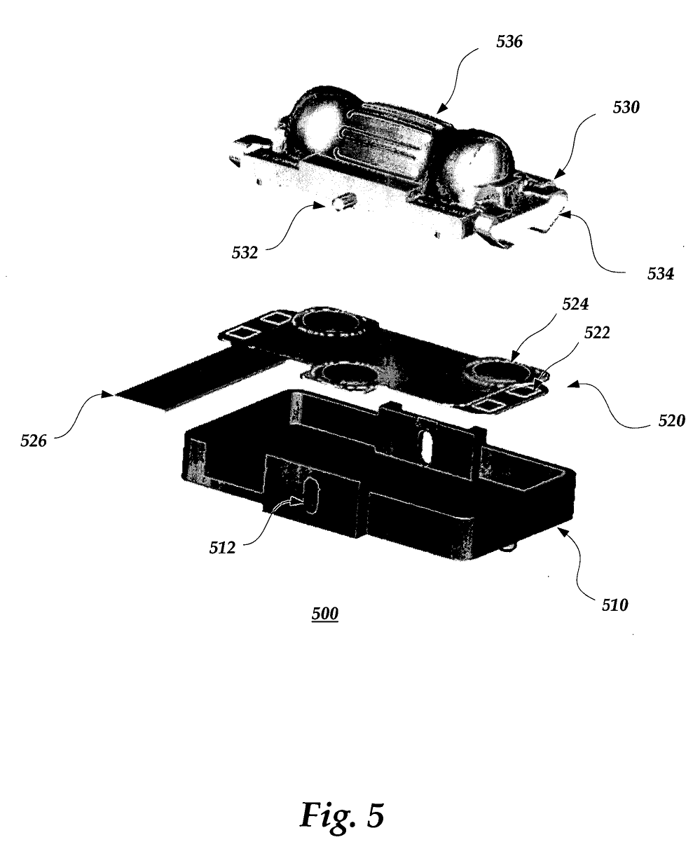

Device base 310 can be a printed circuit board (PCB) that is comprised by an electronic device. Device base 310 provides a surface to which switching assembly 320 can be affixed. Switching assembly 320 can be affixed, for example, by soldering contact/lead 324 to device base 310 at pad 312. Other means, such as retaining arms and/or adhesives (see FIG. 5, for example), can be used to secure switching assembly to device base 310 such that electrical connections are formed between pads 312 and contacts/leads 324. Additionally, securely affixing switching assembly 320 to device base 310 can provide rigidity to the device base, where, for example, the device base is a printed circuit board.

FIG. 4 is a view diagram generally illustrating components of a partially assembled switching assembly in accordance with the present invention. Switching assembly 320 may comprise springs 428 and dome switches 322 (as shown in FIG. 3). Springs 428 may be sized and/or positioned to optimize the activation force for switches 322. Springs 428 may also be arranged to conduct a signal that is modulated by wheel assembly 330.

Dome switches 322 may comprise cover 426, dome contact 424 and base contact 422. Cover 426 is typically arranged to position and affix dome contact 424 on switching assembly surface 326. Dome contact 424 is typically flexible and comprises a conductive material such that when a sufficient activation force is applied, electrical and/or mechanical contact is made with base contact 422. Base contact 422 may be electrically coupled to one or more contacts/leads 324, including, for example, through switching assembly surface 326.

FIG. 5 is an exploded-view diagram generally illustrating components of a wheel assembly device in accordance with the present invention. Illustrated in device 500 are device base 510, switching assembly 520, and wheel assembly 530. In general, device base 510 is configured to receive and captivate (temporarily or permanently) switching assembly 520, and wheel assembly 530. In an embodiment, wheel assembly 530 comprises pins 532 that are arranged to be slideably received by device base 510 and captivated in slot 512, thereby also captivating switching assembly 520. Wheel assembly 530 may also comprise springs 534 for electrically coupling to pad 522 when wheel assembly 530 is captivated. Thus wheel assembly 530 can be electrically coupled to switching assembly 520 without potentially damaging heat encountered during soldering.

Switching assembly 520 comprises switches such as dome switches 524 that are configured to make or break electrical connections when sufficient activation force is applied to wheel 536. Optional cable 526 can be provided to permit electrical connections from assembly 500.

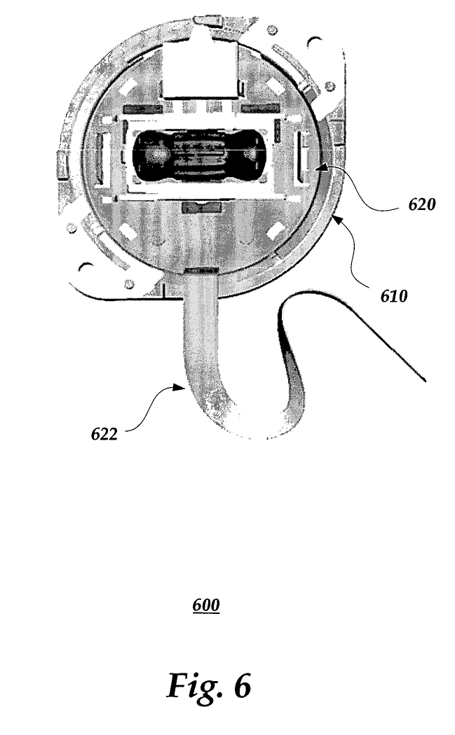

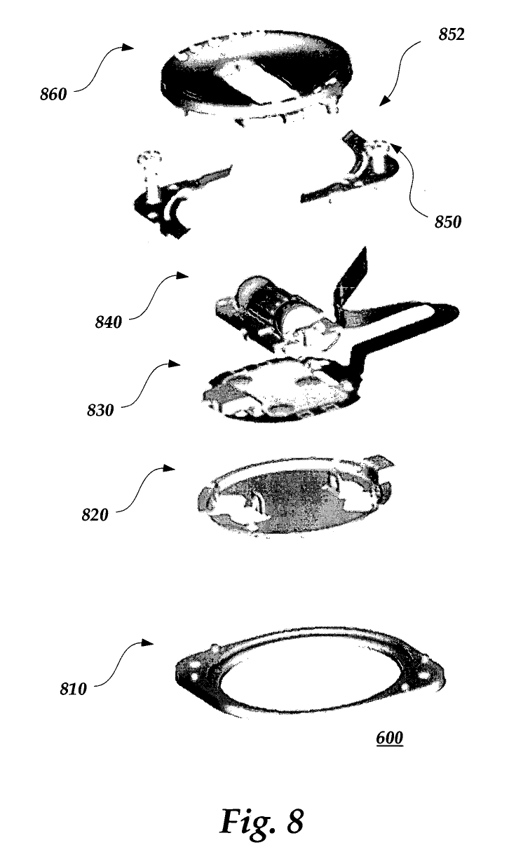

FIG. 6 is a view diagram generally illustrating a wheel assembly device having a turntable in landscape orientation in accordance with the present invention. Illustrated in device 600 are device base 610, switching assembly 620, which has a flexible cable 622. In general, switching assembly 620 is slideably captivated by device base 601 such that switching assembly 620 can be rotated about a vertical axis (which may be perpendicular to the plane defined by the switching assembly). Exemplary components of device 600 are also described with respect to FIG. 8 below.

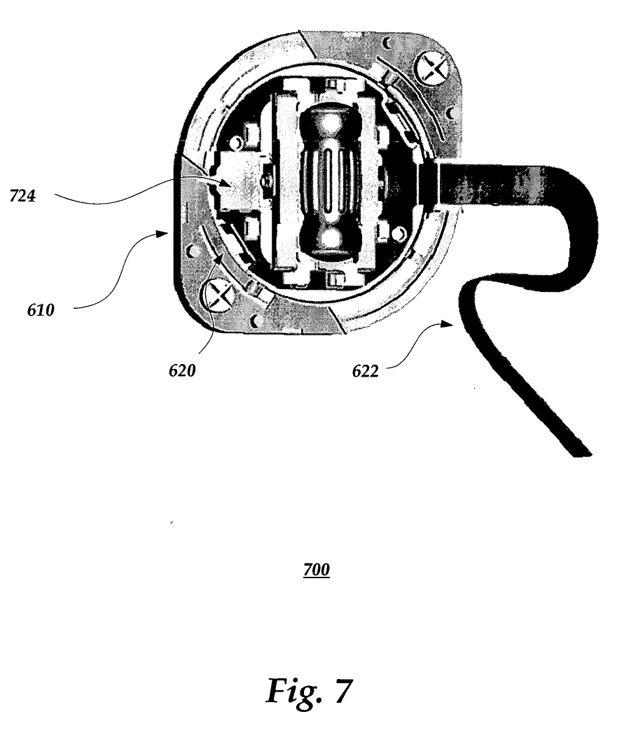

FIG. 7 is a view diagram generally illustrating a wheel assembly device having a turntable in portrait orientation in accordance with the present invention. Illustrated in device 600 are device base 610, switching assembly 620, which has a flexible cable 622. Detent switch 724 can be provided to determine the angle of rotation of switching assembly 620.

As illustrated, switching assembly 620 has been rotated about the vertical axis of the switching assembly (620) such that the wheel can be operated from a different direction in accordance with the convenience of the user. Any degree of rotation throughout a full circle is possible, but typical applications may use a 90 degree angle of rotation such that the wheel assembly can maintains the same orientation when a handheld electronic device is rotated 90 degrees in the hands of a user (e.g., such as when switching from landscape orientation to portrait orientation).

FIG. 8 is an exploded-view diagram generally illustrating a wheel assembly device having a turntable in accordance with the present invention. Illustrated in device 600 are fixed base 810, rotating base 820, switch assembly 830, wheel assembly 840, detent spring 850 having securing means 852, and cap 860. Fixed base 810 may be affixed to an electronic device, and is configured to allow rotating base 820 (and other components affixed thereto) to rotate about a vertical axis.

Rotating base 820 typically comprises switch assembly 830 and wheel assembly 840, and secures switch assembly 830 and wheel assembly 840 such that rotating base 820, switch assembly 830, and wheel assembly 840 rotate as a unit.

Securing means 852 is configured to allow rotating base 820 to rotate (typically some angle of less than 360 degrees, although larger angles are possible), while securing rotating base to fixed base 810. Detent springs 850 may be used to temporarily inhibit rotation of rotating base 820. Cap 860 may be used to shield components of the wheel assembly device, while leaving a substantial upper potion of the wheel to be exposed, which allows a user to manipulate (including depressing and rotating) the wheel.

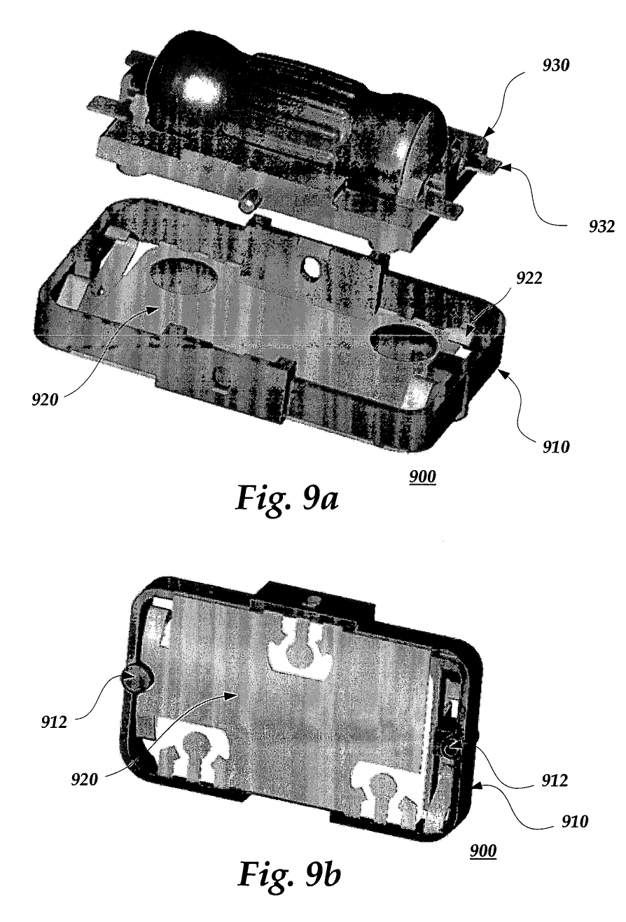

FIG. 9a is a top-view diagram generally illustrating components of a wheel assembly device in accordance with the present invention. Illustrated in device 900 are device base 910, switching assembly 920, and wheel assembly 930. In general, device base 910 is configured to receive and captivate switching assembly 920 (as shown), and wheel assembly 930 (shown above switching assembly 920). In an embodiment, wheel assembly 930 comprises leads 932 that are arranged to be electrically coupled to spring contacts 922 when wheel assembly 930 is inserted into device base 910. Accordingly, wheel assembly 930 can be electrically coupled to switching assembly 920 without potentially damaging heat encountered during soldering.

FIG. 9b is a bottom-view diagram generally illustrating components of a wheel assembly device in accordance with the present invention. Illustrated in device 900 are device base 910, switching assembly 920, and wheel assembly 930. In general, device base 910 (located generally around the perimeter of the Figure) is configured to receive and captivate switching assembly 920 (located generally within device base 910). In an embodiment, device base 910 comprises locating pins 912 that are arranged to position device base 910 when device base 910 inserted into an electronic device (as shown in FIG. 1). Locating pins can have different diameters to ensure proper orientation of the wheel assembly while being assembled in an electronic device.

Other embodiments of the invention are possible without departing from the spirit and scope of the invention. The above specification, examples, and data provide a complete description of the manufacture and use of the composition of the invention. Since many embodiments of the invention can be made without departing from the spirit and scope of the invention, the invention resides in the claims hereinafter appended.

I claim:

1. A pointing device for controlling an electronic device, comprising:
a wheel assembly that comprises a wheel, wherein the wheel assembly is arranged to modulate a signal in response to rotation of the wheel by a user;
a switching assembly that comprises a first, second, and third switch, each of which are generally configured to modulate a signal in response to a user depressing the wheel; and
a device base that is arranged to physically secure the wheel assembly to the switching assembly.

2. The pointing device of claim 1, further comprising an electronic device that is attached to the device base, wherein the electronic device provides displays to the user in response to the modulated signal.

3. The pointing device of claim 2, further comprising a rotating base that is configured to rotate within the device base such that the axis of the rotation of the wheel can be changed by a user of the electronic device.

4. The pointing device of claim 2, further comprising a pivot pin that is arranged at a first point to inhibit both the first and the second switches from modulating a signal in response to a single depression of the wheel.

5. The pointing device of claim 1, wherein the device base is compatible with a soldering process and the wheel is not compatible with a soldering process.

6. The pointing device of claim 1, wherein the device base comprises a printed circuit board.

7. The pointing device of claim 1, wherein the wheel assembly and the switching assembly are arranged to be secured to the device base by a soldering process.

8. A pointing device for controlling an electronic device, comprising:
a wheel means that comprises a wheel, wherein the wheel assembly is arranged to modulate a signal in response to rotation of the wheel by a user;
a switching means that comprises a first, second, and third switch, each of which are generally configured to modulate a signal in response to a user depressing the wheel; and
a device base means that is arranged to physically secure the wheel assembly to the switching assembly.

9. The pointing device of claim 8, further comprising an electronic device that is attached to the device base means, wherein the electronic device provides displays to the user in response to the modulated signal.

10. The pointing device of claim 9, further comprising a rotating base means that is configured to rotate within the device base means such that the axis of the rotation of the wheel can be changed by a user of the electronic device.

11. The pointing device of claim 9, further comprising a pivot means that is arranged at a first point to inhibit both the first and the second switches from modulating a signal in response to a single depression of the wheel.

12. The pointing device of claim 8, wherein the device base means is compatible with a soldering process and the wheel is not compatible with a soldering process.

13. The pointing device of claim 8, wherein the wheel means electrically communicates with the device base means by leaf springs.

14. An electronic device, comprising:
a wheel assembly that comprises a wheel, wherein the wheel assembly is arranged to modulate a signal in response to rotation of the wheel by a user;
a switching assembly that comprises a first, second, and third switch, each of which are generally configured to modulate a signal in response to a user depressing the wheel;
a device base that is arranged to physically secure the wheel assembly to the switching assembly; and
a processor that is arranged to receive the produced signals.

15. The device of claim 14, wherein the processor is further arranged to change an electronic image in response to the produced signals.

16. The device of claim 15, further comprising a display that is arranged to display the electronic image.

17. The device of claim 14, further comprising an application program that is configured to select a particular data field displayed in a list in response to the produced signals.

18. The device of claim 14, wherein the wheel assembly is configured to rotate about an axis that is substantially vertical from the axis of rotation of the wheel, such that the orientation of the wheel assembly is changed with respect to the electronic device.

19. The device of claim 18, further comprising means for determining the orientation of the wheel assembly.

20. The device of claim 19, wherein the processor is further configured to adjust the electronic image in response to the orientation of the wheel assembly.
